(19) United States
(12) Patent Application Publication
(10) Pub. No.: US 2018/0234994 A1
(43) Pub. Date: Aug. 16, 2018

(54) USER APPARATUS AND COMMUNICATION METHOD

(71) Applicant: NTT DOCOMO, INC., Tokyo (JP)

(72) Inventors: Shimpei Yasukawa, Tokyo (JP); Satoshi Nagata, Tokyo (JP); Qun Zhao, Beijing (CN); Yongbo Zeng, Beijing (CN); Yongsheng Zhang, Beijing (CN)

(73) Assignee: NTT DOCOMO, INC., Tokyo (JP)

(21) Appl. No.: 15/749,712

(22) PCT Filed: Aug. 10, 2016
(86) PCT No.: PCT/JP2016/073611

§ 371 Date: Feb. 1, 2018

(30) Foreign Application Priority Data
Aug. 13, 2015 (JP) 2015-159990

(51) Int. Cl. H04W 72/12; H04W 72/02; H04W 92/18; H04W 72/04

(52) U.S. Cl. CPC H04W 72/1242; H04W 72/02; H04W 72/10; H04W 72/0406; H04W 92/18

(57) ABSTRACT

A user apparatus in a radio communication system that supports a Device to Device (D2D) communication is disclosed. The user apparatus includes a first transmission unit configured to transmit radio resource allocation information, in case of transmitting a Medium Access Control (MAC) Protocol Data Unit (PDU) of high priority, by using a specific subframe that is used for transmitting radio resource allocation information corresponding to a MAC PDU of high priority, from among radio resources allocated to a D2D control channel. A second transmission unit is configured to transmit the MAC PDU via a D2D data channel in accordance with the transmitted radio resource allocation information.

### TECHNICAL FIELD

The present invention relates to a user apparatus, and a communication method.

### BACKGROUND ART

In LTE (Long Term Evolution) and a successor system of LTE (e.g., also called LTE-A (LTE-Advanced), FRA (Future Radio Access), 4G, etc.), a D2D (Device to Device) technology that performs direct communications between user terminals without having intervention by a radio base station has been studied (e.g., Non-Patent Document 1). The D2D technology may be able to reduce the traffic between the user apparatuses and the base station and to enable communications between the user apparatuses even when the base station is no longer able to provide communication services at the time of disaster or the like.

In D2D, support is scheduled for direct communications outside coverage and for push call (PTT: push to talk). In 3GPP, a Mission Critical Push To Talk (MCPTT) service that implements a push call at a time of a disaster or the like is being studied (e.g., Non-Patent Document 2).

The D2D technology is roughly divided into a D2D discovery for finding other communicative user terminals and D2D communication for performing direct communications between the terminals (also referred to as a D2D direct communication, an inter-terminal direct communication, etc.). In the following, when the D2D technology is not specifically distinguished as the D2D communication, the D2D discovery etc., the D2D technology is simply called “D2D”. Further, a signal transmitted and received by the D2D is called a D2D signal.

### RELATED ART DOCUMENTS

### Non-Patent Documents

[NON-PATENT DOCUMENT 1] “Key drivers for LTE success: Services Evolution”, September 2011, 3GPP, the Internet URL: http://www.3gpp.org/ftp/Information/presentations/presentations_2011/2011_09_LTE_Asia/2011_LTE-Asia_3GPP_Service_evolution.pdf
[NON-PATENT DOCUMENT 2] 3GPP TS 22.179 V13.2.0 (2015-06)

### SUMMARY OF THE INVENTION

### Problem to be Solved by the Invention

For example, in MCPTT, it is necessary that neighboring user apparatuses reliably receive a high priority communication call originating from a transmitting end user apparatus. Hence, it is desirable that the user apparatuses reliably detect a high priority communication call, and that radio resources be released for the high priority communication call during communication or when some kind of communication is expected.

However, the D2D communication utilizes a part of an uplink resource already defined as a resource for uplink signal transmission from the user apparatus to the base station. That is, D2D is half duplex communication (Half Duplex) that utilizes a common band for transmission and reception, which disables simultaneous transmission and reception of D2D signals in the same subframe. That is, even when a user apparatus of high priority originates a high priority communication call, the receiving end user apparatus will not receive the high priority communication call while the receiving end user apparatus is transmitting a D2D signal.

FIGS. 1A, 1B, and 1C are diagrams illustrating an example where transmission of D2D signals overlaps. FIG. 1A illustrates a case where the user apparatuses UE1 and UE2 transmit SCI (Sidelink Control Information) serving as radio resource allocation information in D2D in the same subframe, and FIG. 1B illustrates a case where the user apparatuses UE1 and the UE2 transmit SCI with the same radio resource.

In D2D, a scheme by which the user apparatus itself randomly selects radio resources is defined in addition to a scheme by which the base station eNB allocates the radio resources. As a result, the states illustrated in FIGS. 1A and 1B may occur. In cases of FIGS. 1A and 1B, the user apparatus UE1 that is currently transmitting SCI is unable to receive SCI transmitted from the user apparatus UE 2. Further, because scheduling information is stored in SCI, if the user apparatus UE1 that is not able to receive SCI, the user apparatus UE1 cannot receive MAC PDU (MAC (Medium Access Control) PDU (Protocol Data Unit)) data subsequently transmitted from the user apparatus UE2.

FIG. 1C is a diagram illustrating a case of a T-RPT (Time Resource Pattern), for indicating a pattern of data transmission timing in which the user apparatus UE1 transmits data simultaneously with all the data transmission timings of the user apparatus UE2, as selected from among T-RPT (Time Resource Patterns) indicating data transmission timing patterns (subframes for data transmission) in the PSSCH (Physical Sidelink Shared Channel) serving as a data transmission channel. In FIG. 1C, “0” indicates timing (subframe) at which data is not transmitted, and “1” indicates timing (subframe) at which data is transmitted. In FIG. 1C, all the transmission timings that are “1” in the T-RPT of the user apparatus UE2 are also “1” in the T-RPT of the user apparatus UE1. That is, because the user apparatus UE1 also transmits data at all the timings at which the user apparatus UE2 transmits data, the user apparatus UE1 is unable to receive the data transmitted from the user apparatus UE2.

The disclosed technology is made in view of the above, and it is an object of the present invention to provide a technology capable of improving the reception rate of high priority data in a D2D communication.

### Means for Solving the Problem

In accordance with an embodiment, a user apparatus in a radio communication system that supports a D2D communication is provided. The user apparatus includes a first transmission unit configured to transmit radio resource allocation information, in case of transmitting a MAC PDU of high priority, by using a specific subframe that is used for transmitting radio resource allocation information corresponding to a MAC PDU of high priority, from among radio resources allocated to a D2D control channel; and a second transmission unit configured to transmit the MAC PDU via a D2D data channel in accordance with the transmitted radio resource allocation information.

In accordance with an embodiment, a user apparatus in a radio communication system that supports a D2D communication is provided. The user apparatus includes a receiving unit configured to receive radio resource allocation information via a D2D control channel and receive a MAC PDU corresponding to the received radio resource allocation information via a D2D data channel; and a transmission unit configured to transmit a MAC PDU for another user apparatus, and to stop transmission of the MAC PDU for the another user apparatus: in a case where the received radio resource allocation information has been received in a specific subframe for transmitting radio resource allocation information corresponding to a MAC PDU of high priority, from among radio resources allocated to the D2D control channel; in a case where the received radio resource allocation information includes information indicating that transmission of the MAC PDU of high priority is scheduled; or in a case where information indicating that the MAC PDU of high priority is included in the subheader of the MAC PDU that has been received by the receiving unit.

### Advantageous Effect of the Present Invention

According to the disclosed technology, it is possible to improve the reception rate of high priority data in the D2D communication.

### BRIEF DESCRIPTION OF THE DRAWINGS

FIG. 1A is a diagram illustrating an example where transmission of D2D signals overlaps;

FIG. 1B is a diagram illustrating an example where transmission of D2D signals overlaps;

FIG. 1C is a diagram illustrating an example where transmission of D2D signals overlaps;

FIG. 2 is a diagram illustrating a configuration example of a radio communication system according to an embodiment of the present invention;

FIG. 3 is a diagram illustrating a D2D communication;

FIG. 4 is a diagram illustrating a MAC PDU for use in a D2D communication;

FIG. 5 is a diagram illustrating a format of an Sidelink Shared Channel (SL-SCH) subheader;

FIG. 6 is a sequence diagram illustrating an example of a process flow performed between user apparatuses according to an embodiment of the present invention;

FIG. 7A is a diagram illustrating an example of an SCI transmission method according to an embodiment;

FIG. 7B is a diagram illustrating an example of an SCI transmission method according to an embodiment of the present invention;

FIG. 7C is a diagram illustrating an example of an SCI transmission method according to an embodiment of the present invention;

FIG. 7D is a diagram illustrating an example of an SCI transmission method according to an embodiment of the present invention;

FIG. 8 is a diagram illustrating an example (part 1) of radio resources for transmitting a “Pre-emption signal”;

FIG. 9 is a diagram illustrating an example (part 2) of radio resources for transmitting a “Pre-emption signal”;

FIG. 10A is a diagram illustrating an example of an SL-SCH subheader of a MAC PDU including a “pre-emption signal”;

FIG. 10B is a diagram illustrating an example of an SL-SCH subheader of a MAC PDU including a “pre-emption signal”;

FIG. 10C is a diagram illustrating an example of an SL-SCH subheader of a MAC PDU including a “pre-emption signal”;

FIG. 11 is a diagram illustrating an example of a resource pool for a user apparatus of high priority;

FIG. 12 is a diagram illustrating an example of a functional configuration of a user apparatus according to an embodiment of the present invention;

FIG. 13 is a diagram illustrating an example of a functional configuration of a base station according to an embodiment of the present invention; and

FIG. 14 is a diagram illustrating an example of a hardware configuration of the user apparatus and the base station according to an embodiment of the present invention.

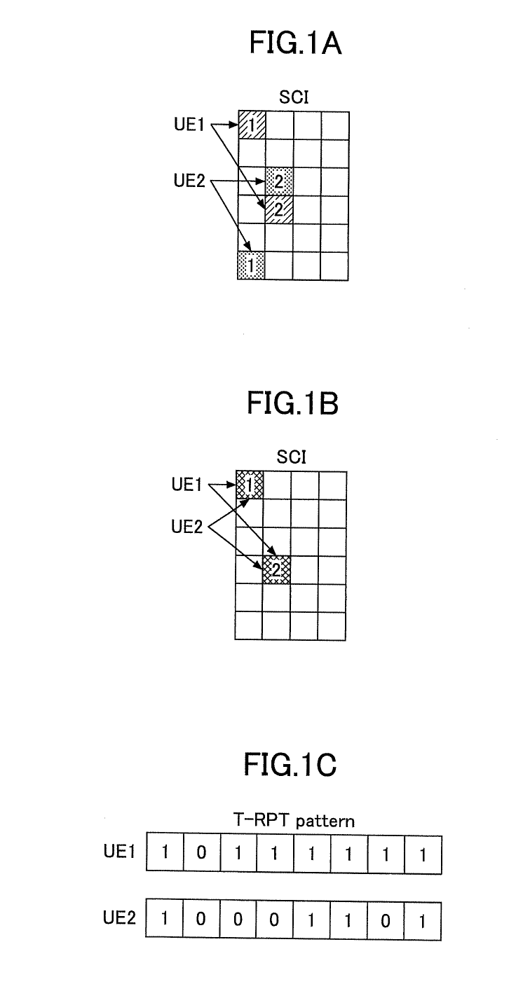

### EMBODIMENTS FOR CARRYING OUT THE INVENTION

The following describes embodiments of the present invention with reference to the accompanying drawings. Note that the embodiments described below are merely examples and the embodiments to which the present invention is applied are not limited to the following embodiments. For example, it is assumed that a radio communication system according to an embodiment complies with LTE standards. However, the present invention may be applied not limited to LTE but may also be applied to other systems. Note that, in the specification and the claims, the term “LTE” is used not only to mean a communication scheme corresponding to 3GPP release 8 or 9, but also to mean the fifth-generation mobile communication system corresponding to 3GPP release 10, 11, 12, 13, 14 or later.

### Outline

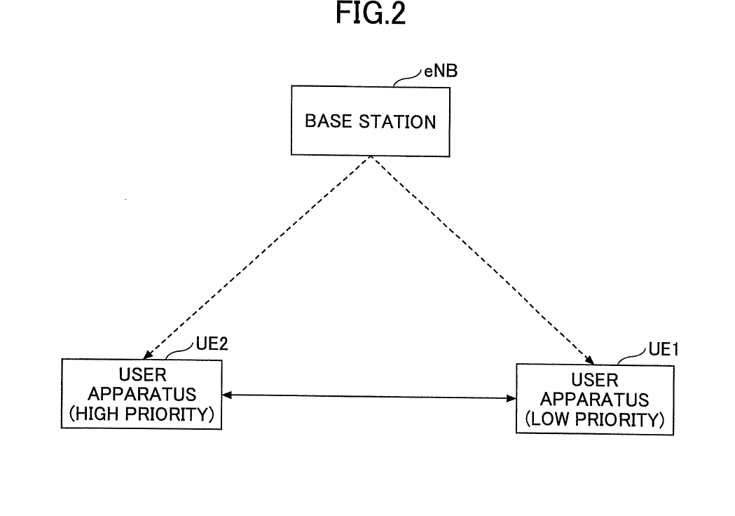

As illustrated in FIG. 2, a radio communication system according to an embodiment includes a base station eNB and user apparatuses UE1 and UE2. The base station eNB allocates a resource pool and the like for use in transmission and reception of the D2D signal, for example, using broadcast information (system information block: SIB) or RRC (Radio Resource Control) etc. of a macro cell. In the following description, any one of the user apparatus UE1 and user apparatus UE2 will be referred to as a “user apparatus UE”.

In this embodiment, it is assumed that the user apparatus UE2 is a user apparatus UE that initiates a high priority communication such as MCPPT whereas the user apparatus UE1 is a general user apparatus UE having a priority lower than that of the user apparatus UE 2. FIG. 2 illustrates one each of the user apparatus UE1 and the user apparatus UE2 for convenience; however, there are no limitations to the number of the user apparatuses UE1 and to the number of the user apparatuses UE2.

In the present embodiment, a signal for reporting to neighboring user apparatuses UEs that the user apparatus UE2 initiates high-priority communication is referred to as a “Pre-emption signal” for convenience. There is no specific limitation to the content of information included in the Pre-emption signal; however, the information included in the Pre-emption signal may be high priority information such as information for reserving radio resources for transmitting data in emergency calls.

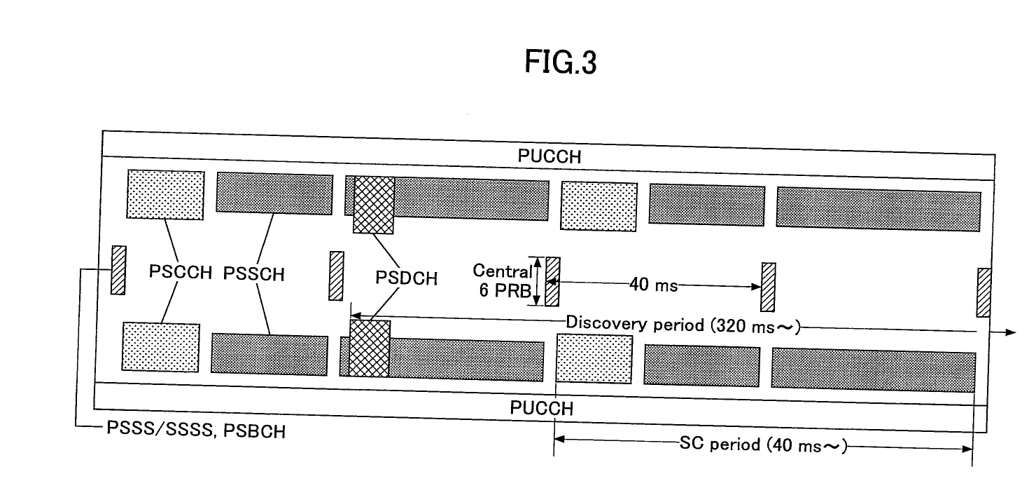

The following illustrates an outline of D2D signal transmission in LTE. FIG. 3 illustrates a configuration of an entire physical channel in D2D. With respect to “Discovery”, as illustrated in FIG. 3, a Discovery message resource pool is secured for each Discovery period, and the user apparatus UE transmits a Discovery message within such a resource pool. More specifically, in “Discovery”, there is a Type 1 and a Type 2b as follows: In Type 1, the user apparatus UE autonomously selects transmission resources from the resource pool. In Type 2b, quasi-static resources are allocated by higher layer signaling (e.g., RRC signal).

With respect to “Communication”, as illustrated in FIG. 3, a Control/Data transmission resource pool is periodically secured. The period during which the resource pool is secured is called a “SC Period”. The transmitting end user apparatus UE reports a data transmission resource and the like to the receiving end user apparatus UE by SCI using a resource selected from the Control resource pool and transmits the data through the data transmission resource. The receiving end user apparatus UE receives the data by monitoring the data transmission resource using the information (T-RPT, radio resource allocation information, Modulation Coding Scheme (MCS), etc.) included in the acquired SCI.

Specifically, in the “Communication”, there is a Mode 1 and a Mode 2 as follows: In Mode 1, resources are dynamically allocated by an Enhanced (E) Physical Downlink Control Channel (PDCCH) transmitted from the base station eNB to the user apparatus UE. In Mode 2, the user apparatus UE autonomously selects transmission resources from the Control/Data transmission resource pool. The resource pool used may be reported by SIB or a predefined resource pool may be used.

In LTE, the channel for use in “Discovery” is called PSDCH (Physical Sidelink Discovery Channel); in “Communication”, the channel for transmitting control information such as SCI is called PSCCH (Physical Sidelink Control Channel), and the channel for transmitting data is PSSCH (Physical Sidelink Shared Channel).

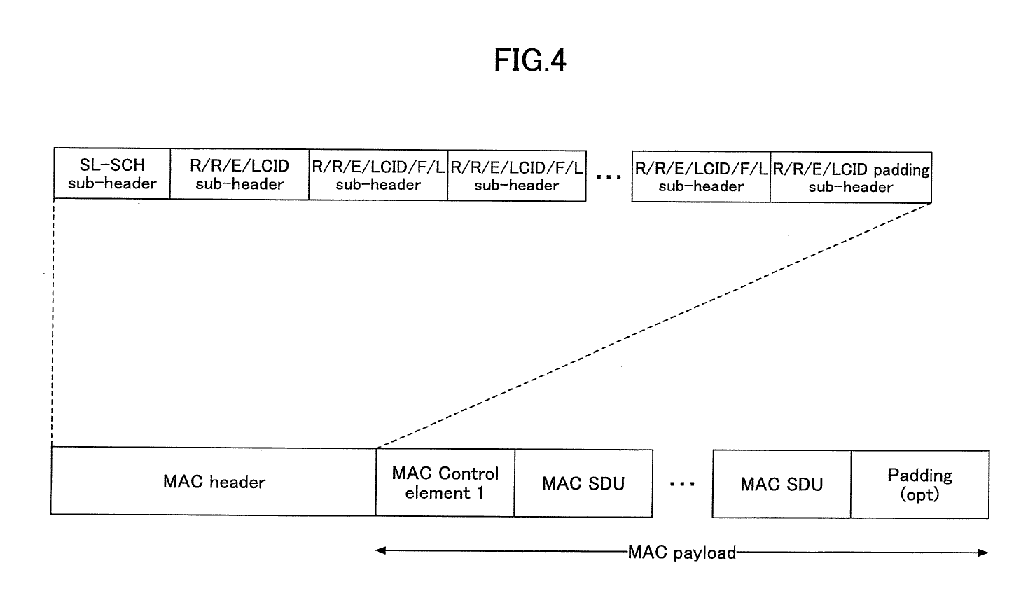

As illustrated in FIG. 4, the MAC PDU for use in the D2D communication includes at least a MAC header, MAC Control element, MAC SDU (Service Data Unit), and Padding. The MAC PDU may contain other information. The MAC header includes one SL-SCH (Sidelink Shared Channel) subheader and one or more MAC PDU subheaders.

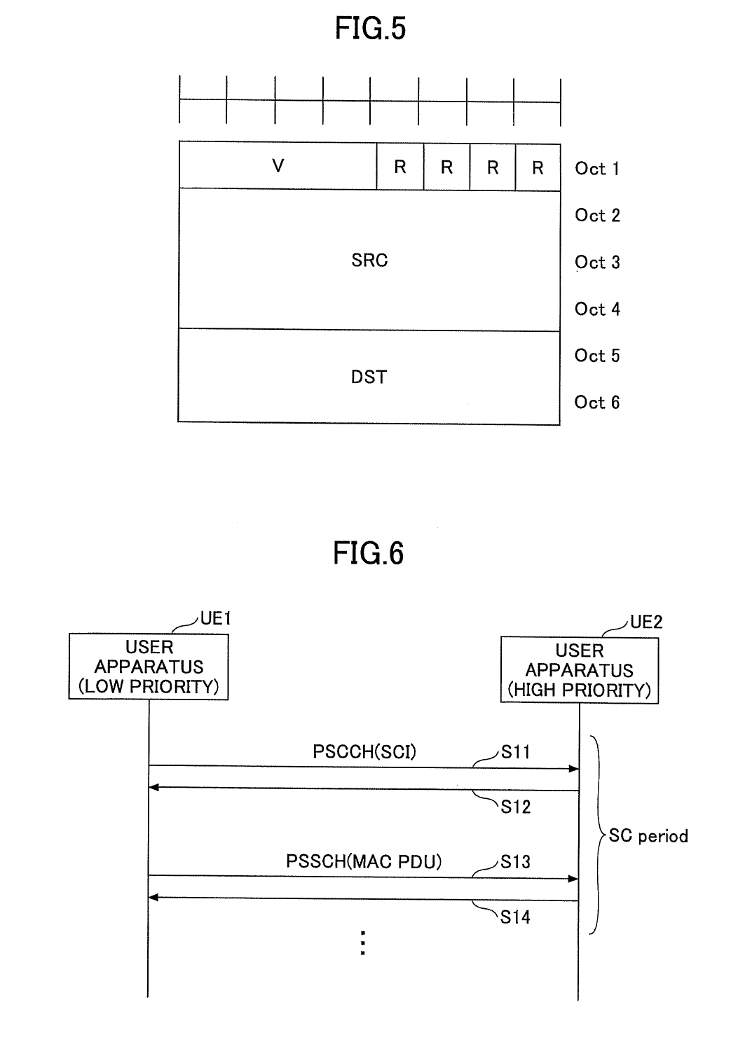

As illustrated in FIG. 5, the SL-SCH subheader includes a MAC PDU format version (V), transmission source information (SRC), transmission destination information (DST), Reserved bit (R) and the like. V is allocated to the head of the SL-SCH subheader and indicates a MAC PDU format version used by the user apparatus UE. Information related to the transmission source is set as transmission source information. An identifier for ProSeUEID may be set in the transmission source information. Information related to the transmission destination is set as transmission destination information. Information on ProSeLayer-2 Group ID of a transmission destination may also be set as the transmission destination information.

In the present embodiment, the user apparatus UE may be applied to any user apparatuses UEs that supports D2D communications. In the following description, it is assumed that the user apparatus UE2 is configured to transmit the “Pre-emption signal”. However, the present embodiment is not limited to the example where the “Pre-emption signal” that is to be transmitted by user apparatus UE2. Other data may be applied in place of the Pre-emption signal” is to be transmitted by user apparatus UE2. In the following description, a “MAC PDU of high priority” applies to indications including a MAC PDU associated with the “Pre-emption signal”, a MAC PDU generated from data transmitted via a logical channel set with high priority, a MAC PDU generated from the U-plane data set with high priority, and the like. The following illustrates specific processes performed by the radio communication system in the present embodiment.

### Process Flow

### Processing Flow for Receiving Mac PDU of High Priority

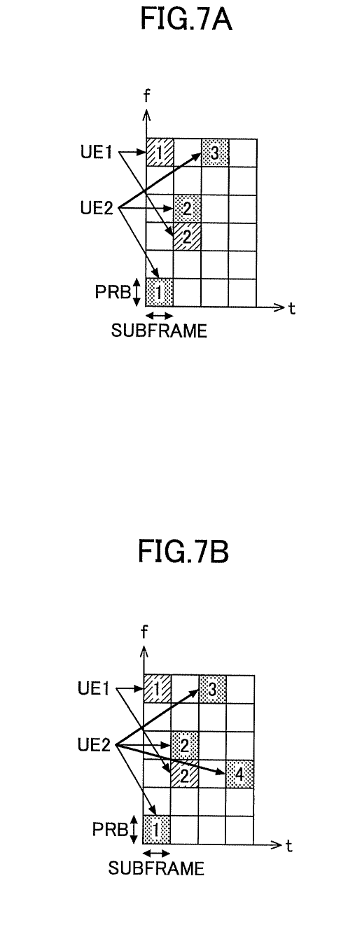

FIG. 6 is a sequence diagram illustrating an example of a process flow performed between user apparatuses in the embodiment. With reference to FIG. 6, a description is given of an example of a process flow where the user apparatus UE1 detects that the user apparatus UE2 is about to start high priority communications in a case where the user apparatus UE1 and the user apparatus UE2 simultaneously transmit data.

In FIG. 6, it is assumed that the user apparatus UE1 transmits optional data (e.g., data for user in “Communication”) included in a MAC PDU, and the user apparatus UE2 transmits the “Pre-emption signal” included in a MAC PDU. FIG. 6 depicts an example where the user apparatus UE1 and the user apparatus UE2 transmit and receive D2D signals with each other; however, the present embodiment is not limited to this example. The embodiment also includes an example where each of the user apparatus UE1 and the user apparatus UE2 transmits and receives D2D signals with an unspecified user apparatus UE and includes an example where each of the user apparatus UE1 and the user apparatus UE2 transmits and receives D2D signals with user apparatuses UEs of a specific group. Note that, in a subframe in which a given user apparatus UE is not transmitting a D2D signal, the user apparatus UE monitors a D2D signal transmitted from another user apparatus UE.

First, each of the user apparatus UE1 and the user apparatus UE2 transmit SCI via the PSCCH in order to start transmitting a MAC PDU (steps S11 and S12). In the present embodiment, the user apparatus UE2 transmits SCI so as not to overlap with the timing at which the user apparatus UE1 transmits SCI in order to enable the user apparatus UE1 to receive SCI. The following specifically illustrates a method by which the user apparatus UE2 transmits SCI, with reference to the accompanying drawings.

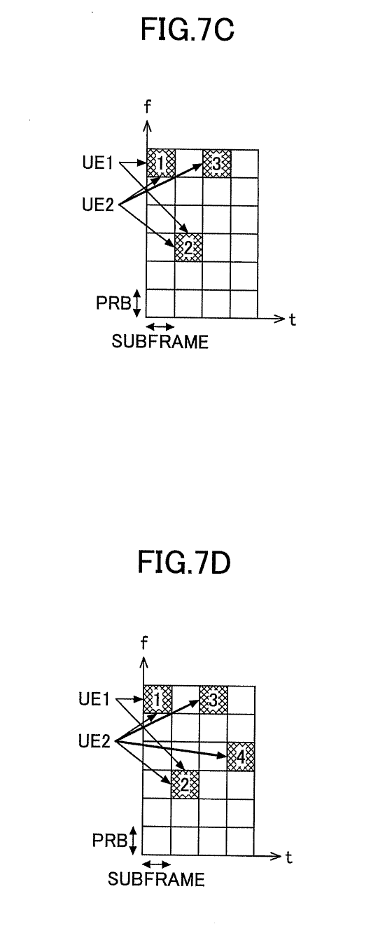

FIGS. 7A, 7B, 7C and 7D are diagrams each illustrating an example of an SCI transmission method according to an embodiment. According to the conventional D2D definitions, the identical SCI is repeatedly transmitted twice in the same SC period. In the embodiment, the user apparatus UE2 is configured to repeatedly transmit SCI three times or more.

FIGS. 7A and 7C illustrate examples of PSCCH resources that map SCI in a case where the user apparatus UE2 repeatedly transmits SCI three times, and FIGS. 7B and 7D illustrate examples of the PSCCH resources that map SCI in a case where the user apparatus UE2 repeatedly transmits SCI four times. The user apparatus UE1 transmits SCI twice in accordance with the conventional D2D definitions. Hence, even when the subframes in which each of the user apparatus UE1 and the user apparatus UE2 transmits SCI are overlapped, as illustrated in FIGS. 7A, 7B, 7C and 7D, the user apparatus UE1 is still able to receive SCI. That is, the user apparatus UE1 is able to receive at least SCI (SCI of “3” and “4” in FIGS. 7A, 7B, 7C and 7D) transmitted by the user apparatus UE2 from the third time onward.

In the present embodiment, a radio resource capable of transmitting only SCI corresponding to a MAC PDU of high priority among the radio resources allocated to the PSCCH is reserved in advance, and the user apparatus UE1 of low priority is configured to constantly monitor the reserved radio resource. For example, the subframes in which SCIs shown in “3” and “4” in FIGS. 7A, 7B, 7C and 7D are transmitted may be radio resources capable of transmitting only SCI corresponding to a MAC PDU of high priority. When receiving SCI in such subframes, the user apparatus UE1 may be able to detect in advance that a MAC PDU of high priority is about to be transmitted.

Further, in the present embodiment, the user apparatus UE2 may include in SCI an identifier indicating that a MAC PDU of high priority is scheduled to be transmitted. Further, one or more specific T-RPTs used only for transmission of a MAC PDU of high priority among the multiple T-RPTs defined in LTE are defined in advance, and the user apparatus UE2 may select such preliminary defined specific T-RPTs. The user apparatus UE1 having received the identifier or SCI including the specific T-RPT may thus be able to detect in advance that a MAC PDU of high priority is about to be transmitted.

Note that a radio resource with which only the user apparatus UE2 of high priority is capable of transmitting SCI and a specific T-RPT used only for transmission of a MAC PDU of high priority may be reported from the base station eNB to the user apparatus UE via an RRC signal, broadcast information (SIB), and a control signal of the layer 1 or layer 2. The priority information may be set in advance in a SIM (Subscriber Identity Module) or may be reported via a control signal of the higher layer transmitted from a core network. The subsequent illustration is given below by referring back to FIG. 6.

Next, the user apparatus UE1 and the user apparatus UE2 respectively transmit MAC PDUs via the PSSCH (steps S13 and S14). Note that the user apparatus UE2 transmits the MAC PDU with a specific radio resource so as to enable the user apparatus UE1 to receive the MAC PDU having the “Pre-emption signal”. The following illustrates specific radio resources with reference to the accompanying drawings.

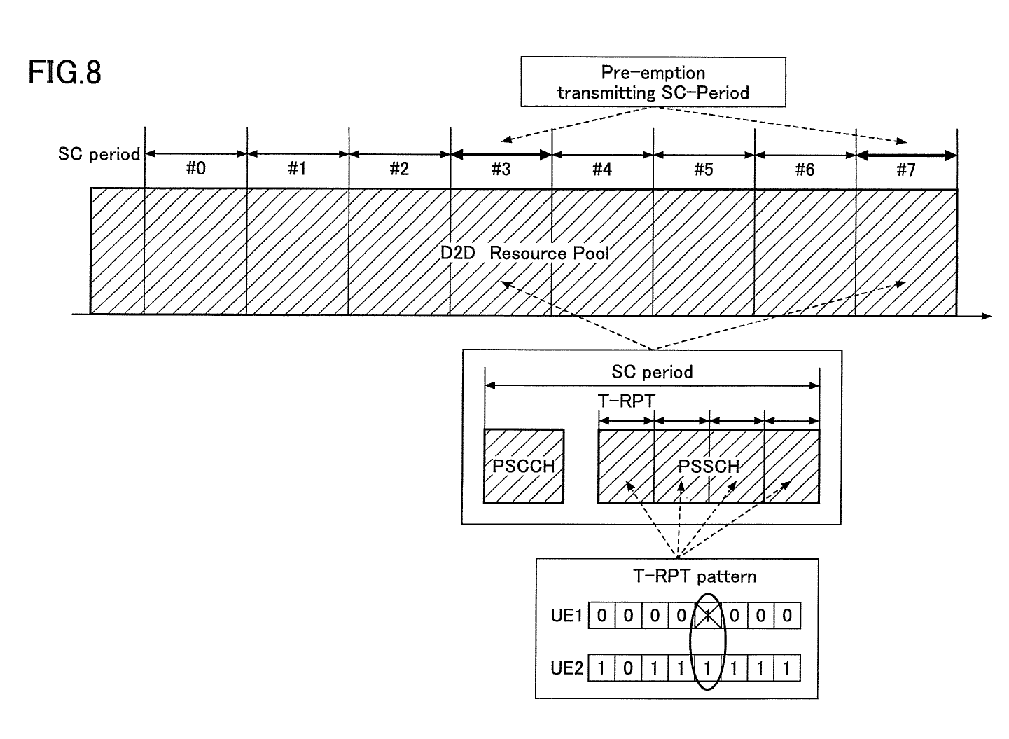

FIG. 8 is a diagram illustrating an example (part 1) of radio resources for transmitting a “Pre-emption signal”. In the embodiment, a specific SC Period among resource pools allocated to the D2D communication may be allocated as radio resources for transmitting a “Pre-emption signal”. As illustrated in FIG. 8, a specific SC Period may be allocated periodically (“SC Period #3”, “SC Period #7”, etc. in FIG. 8).

The user apparatus UE2 of high priority may select a T-RPT having a number of transmission timings for transmitting a MAC PDU being equal to or greater than a predetermined threshold in a specific SC period. The user apparatus UE1 of low priority may select a T-RPT having a number of transmission timings for transmitting the MAC PDU being equal to or less than the predetermined threshold in the specific SC period. The predetermined threshold may be the same value or a predetermined threshold used by the user apparatus UE2 of high priority and a predetermined threshold used by the user apparatus UE1 of low priority may be the same value or may be different values. As an example, the predetermined threshold used by the user apparatus UE2 of high priority may be “7”, whereas the predetermined threshold used by the user apparatus UE1 of low priority may be “1”.

When the user apparatus UE1 and the user apparatus UE2 select the T-RPT illustrated in FIG. 8, the number of overlapping transmission timings (subframes) is only one (one subframe), among MAC PDUs transmitted by the user apparatus UE1 and the user apparatus UE2. That is, a user apparatus UE is able to receive the MAC PDU including the “Pre-emption signal” transmitted by the user apparatus UE2 in a subframe other than the overlapped subframe.

In order to enable the user apparatus UE to identify a specific periodically allocated SC Period, an identifier that uniquely identifies the SC Period may be provided in advance, and the specific SC Period may be identified by a math formula of n+KT (“n” represents an offset value, “K” represents an integer (1, 2, 3 . . . ), “T” represents an interval). In the example of FIG. 8, n=−1 and T=4. In addition, the SC Period #0 may be taken with the DFN (Direct Frame Number) cycle as the first SC Period to be included in entirety.

Note that the predetermined threshold used by the user apparatus UE2 of high priority, the predetermined threshold used by the user apparatus UE1 of low priority level, and the values of “n” and “T” may be reported from the base station eNB to the user apparatus UE via the RRC signal, the broadcast information (SIB), and the control signal of the layer 1 or layer 2. The priority information may be set in advance in a SIM (Subscriber Identity Module) or may be reported via a control signal of the higher layer transmitted from a core network.

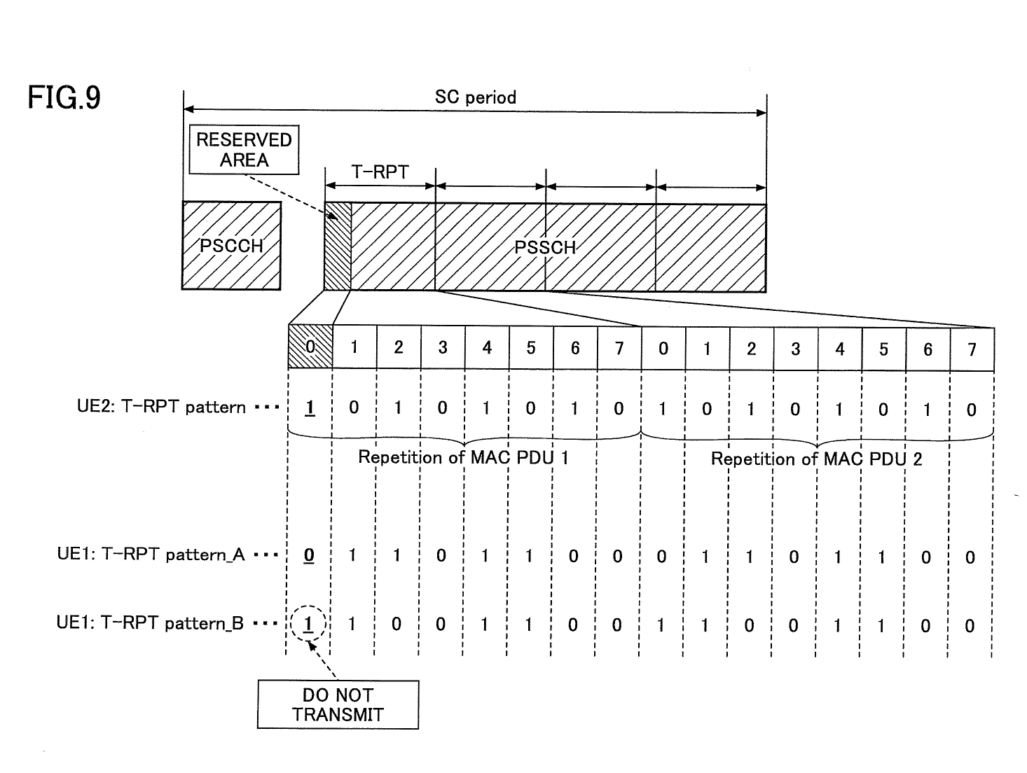

FIG. 9 is a diagram illustrating an example (part 2) of radio resources for transmitting a “Pre-emption signal”. In the embodiment, a specific subframe of the PSSCH radio resource included in each SC Period, among the resource pools allocated to the D2D communication, may be allocated as a radio resource for transmitting the “Pre-emption signal”. The number of the specific subframes may be one, or two or more. In the example of FIG. 9, the first subframe of the PSSCH (“reserved area” in FIG. 9) is allocated as a specific subframe.

The user apparatus UE2 of high priority selects a T-RPT having a pattern of transmitting the MAC PDU including the “Pre-emption signal” in the specific subframe. By contrast, the user apparatus UE1 of low priority monitors the D2D signal without transmitting the MAC PDU in a specific subframe. Specifically, as shown in “T-RPT pattern_A” in FIG. 9, the user apparatus UE1 monitors a specific subframe by selecting a T-RPT of a pattern that will not transmit a MAC PDU in a specific subframe.

As described above, when the user apparatus UE1 is able to detect in advance that a MAC PDU of high priority is about to be transmitted at the time of receiving an SCI, the user apparatus UE1 may stop transmitting a MAC PDU in a specific subframe (a MAC PDU may be discarded before transmission) to monitor the specific subframe. For example, as illustrated in “T-RPT pattern_B” in FIG. 9, in a case where the user apparatus UE1 has selected the T-RPT having a pattern of transmitting a MAC PDU in a specific subframe, the user apparatus UE1 may stop transmitting a MAC PDU in the specific subframe (discard the MAC PDU before transmission) to monitor the specific subframe. Note that in a case where the T-RPT included in SCI received in step S12 of FIG. 6 is a T-RPT with a pattern of transmitting a MAC PDU in the specific subframe, the user apparatus UE1 may recognize that a MAC PDU of high priority is about to be transmitted. Further, when the MAC PDU is received in a specific subframe, the user apparatus UE1 may recognize that the MAC PDU of high priority has been received.

As described above, since the user apparatus UE1 monitors without transmitting a MAC PDU in the specific subframe, the user apparatus UE1 may be enabled to receive the MAC PDU including the “Pre-emption signal” transmitted by the user apparatus UE2.

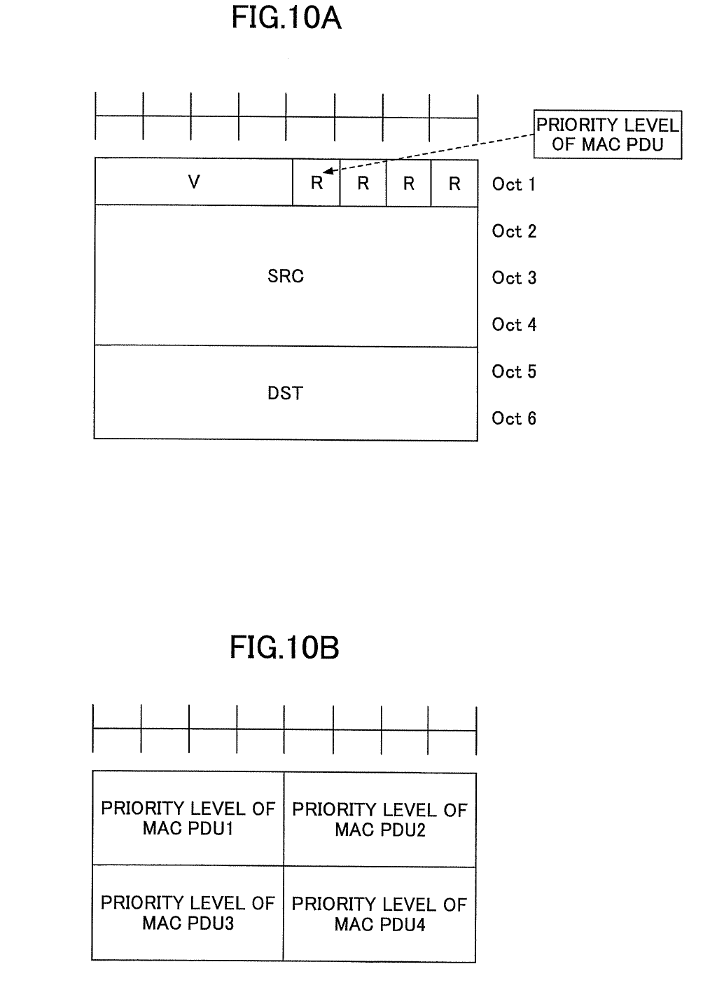

FIGS. 10A, 10B and 10C are diagrams each illustrating an example of an SL-SCH subheader of the MAC PDU including the “Pre-emption signal”. As illustrated in FIG. 10A, the user apparatus UE2 may set, to a reserved bit (R) included in the SL-SCH subheader, an identifier indicating that a MAC PDU of high priority (the MAC PDU including “Pre-emption signal”). As a result, the user apparatus UE1 may be enabled to recognize that the MAC PDU of high priority has been received by referring to the SL-SCH subheader of the received MAC PDU.

As illustrated in FIG. 10B, the user apparatus UE2 may include, in the header part of the MAC PDU, a subheader capable of setting an identifier indicating the priorities of multiple MAC PDUs to be transmitted. The subheader is set for each of the MAC PDUs. With inclusion in the subheader as illustrated in FIG. 10B, the user apparatus UE1 may be enabled to recognize that the MAC PDUs (the MAC PDUs 2, 3, and 4) scheduled to be transmitted by the user apparatus UE2 after the MAC PDU (the MAC PDU 1) also have a high priority. As illustrated in FIG. 10C, a subheader including the priority level of the MAC PDU and an LCID (Logical Channel ID) corresponding to the MAC PDU may be defined.

Processing Flow when Mac PDU of High Priority is Recognized

In a case where the user apparatus UE1 detects in advance that a MAC PDU of high priority is about to be transmitted via the received SCI, or in a case where the user apparatus UE1 recognizes that a MAC PDU of high priority has been received via the received MAC PDU subheader, the user apparatus UE1 may stop or suspend transmission of the MAC PDU scheduled to be transmitted by the user apparatus UE1 itself (discard the MAC PDU before transmission) in order to receive the “Pre-emption signal”. For example, in FIG. 9, the user apparatus UE1 may stop transmission of the MAC PDUs in all subframes subsequent to the specific subframe to receive a “Pre-emption signal” transmitted from the user apparatus UE2.

The user apparatus UE1 may be enabled to recognize the subframe in which the user apparatus UE2 is scheduled to transmit the MAC PDU from the T-RPT transmitted by the user apparatus UE2. Accordingly, Accordingly, suspension of MAC PDU transmission may be limited only to the subframe in which the user apparatus UE2 is scheduled to transmit MAC PDU, in order to receive the “Pre-emption signal” transmitted from the user apparatus UE2. For example, the user apparatus UE1 may stop transmitting the MAC PDU only in the subframes in which both the T-RPT of the user apparatus UE2 and the T-RPT of the user apparatus UE1 are “1” in FIG. 9.

### Modification

In the embodiment, a resource pool for transmitting the D2D signal may be secured in advance by the user apparatus UE2 of high priority.

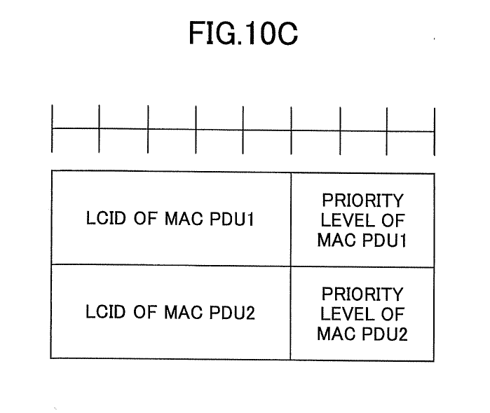

FIG. 11 is a diagram illustrating an example of a resource pool for a user apparatus of high priority. As illustrated in FIG. 11, among resource pools allocated to D2D communication, a specific resource pool may be secured as a resource pool for the “Pre-emption signal” transmission. The user apparatus UE1 of low priority may be configured not to transmit a D2D signal with respect to the resource pool but to monitor whether the user apparatus UE2 of high priority transmits the D2D signal. The user apparatus UE2 of high priority may be configured to transmit SCI and the MAC PDU using the resource pool only for transmitting the “Pre-emption signal”.

Information indicating a resource pool for a user apparatus of high priority may be reported from the base station eNB to the user apparatus UE via the RRC signal, broadcast information (SIB), or the control signal of the layer 1 or layer 2. The priority information may be set in advance in a SIM (Subscriber Identity Module) or may be reported via a control signal of the higher layer transmitted from a core network.

### Functional Configuration

The following illustrates examples of functional configurations of the user apparatus UE and the base station eNB that perform the operations of the above-described embodiment.

### User Apparatus

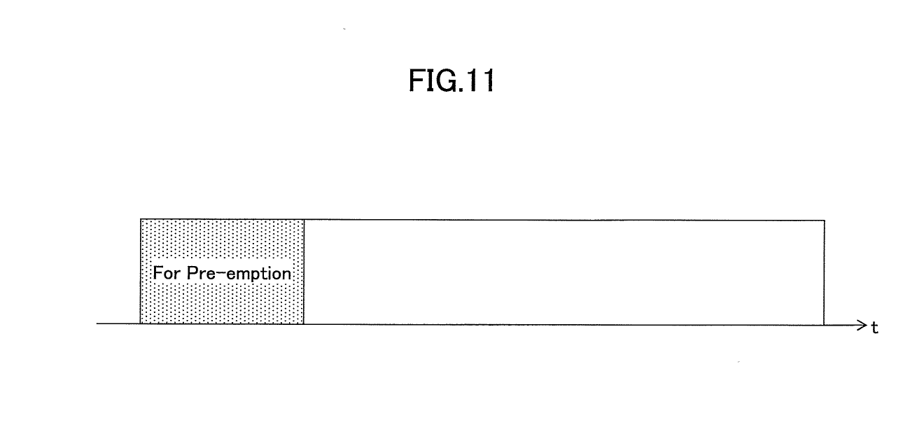

FIG. 12 is a diagram illustrating an example of a functional configuration of a user apparatus according to an embodiment. As illustrated in FIG. 12, the user apparatus UE includes a signal transmitter 101, a signal receiving unit 102, and a detecting unit 103. Note that FIG. 12 merely illustrates the functional configuration particularly related to the embodiment of the present invention in the user apparatus UE, and the user apparatus UE may also include not-illustrated functions for performing, at the least, operations in compliance with LTE. The functional configuration of the user apparatus UE illustrated in FIG. 12 is merely an example. Any functional division and any names of the functional components may be applied insofar as the operations according to the present embodiment may be executed.

The signal transmission unit 101 includes a function to generate various types of signals of the physical layer from the signals of a higher layer to be transmitted from the user apparatus UE and to wirelessly transmit the generated signals. The signal transmission unit 101 further includes a function to transmit a D2D signal (SCI, MAC PDU, etc.) and a function to transmit a signal in a cellular communication system. The signal transmission unit 101 may be divided into a first transmission unit configured to transmit SCI and a second transmission unit configured to transmit a MAC PDU in accordance with SCI.

Further, when transmitting the MAC PDU of high priority (MAC PDU including the “Pre-emption signal”), the signal transmission unit 101 may transmit the SCI by using a specific subframe for transmitting an SCI corresponding to a MAC PDU of high priority among the radio resources allocated to the PSCCH. The signal transmission unit 101 may repeatedly transmit SCI three times or more when transmitting the MAC PDU of high priority.

When transmitting a MAC PDU of high priority, the signal transmission unit 101 may transmit an SCI with selection of a T-RPT indicating that a number of transmission timings enabled to transmit a MAC PDU transmission is greater than or equal to a predetermined threshold in a specific radio resource (a specific SC Period) among the radio resources allocated to the D2D communication.

When transmitting a MAC PDU with a high priority, the signal transmission unit 101 may transmit an SCI with selection of a T-RPT enabled to transmitting a MAC PDU in a specific subframe for use in transmitting a MAC PDU with a high priority among radio resources allocated to the PSSCH. In addition, the signal transmission unit 101 may transmit a MAC PDU having a subheader portion including information indicating that the MAC PDU includes a MAC PDU of high priority.

The signal receiving unit 102 includes a function to wirelessly receive various signals from another user apparatus UE or the base station eNB, and a function to acquire signals of a higher layer from the received signals of the physical layer. Further, the signal receiving unit 102 includes a function to receive a D2D signal (SCI, MAC PDU, etc.) and a function to receive a signal in the cellular communication system.

The detecting unit 103 includes a function to detect that a MAC PDU of high priority is about to be transmitted and a function to detect that a MAC PDU of high priority has been received, based on the information included in SCI or the MAC PDU received by the signal receiving unit 102.

Note that the detecting unit 103 may detect that a MAC PDU of high priority is about to be transmitted when SCI is received in a specific subframe for transmitting a MAC PDU of high priority among the radio resources allocated to the PSCCH, or when information indicating that transmission of a MAC PDU of high priority is scheduled is included in SCI. Additionally, the detecting unit may detect that a MAC PDU of high priority has been received when there is inclusion of information indicating that a MAC PDU of high priority is included within the sub-header of the MAC PDU.

In addition, when the detecting unit 103 has detected that a MAC PDU of high priority is about to be transmitted, and when the detecting unit 103 has received a MAC PDU of high priority, the detecting unit 103 may indicate to the signal transmission unit 101 that the signal transmission unit 101 suspends transmission of the MAC PDU. The detecting unit 103 may indicate to the signal transmission unit 101 that the signal transmission unit 101 suspends the transmission of MAC PDU with respect to the subframe specified by a T-RPT included in an SCI received from another user apparatus UE. Note that the detecting unit 103 may be included in the signal receiving unit 102 or may be included in the signal transmission unit 101.

### Base Station

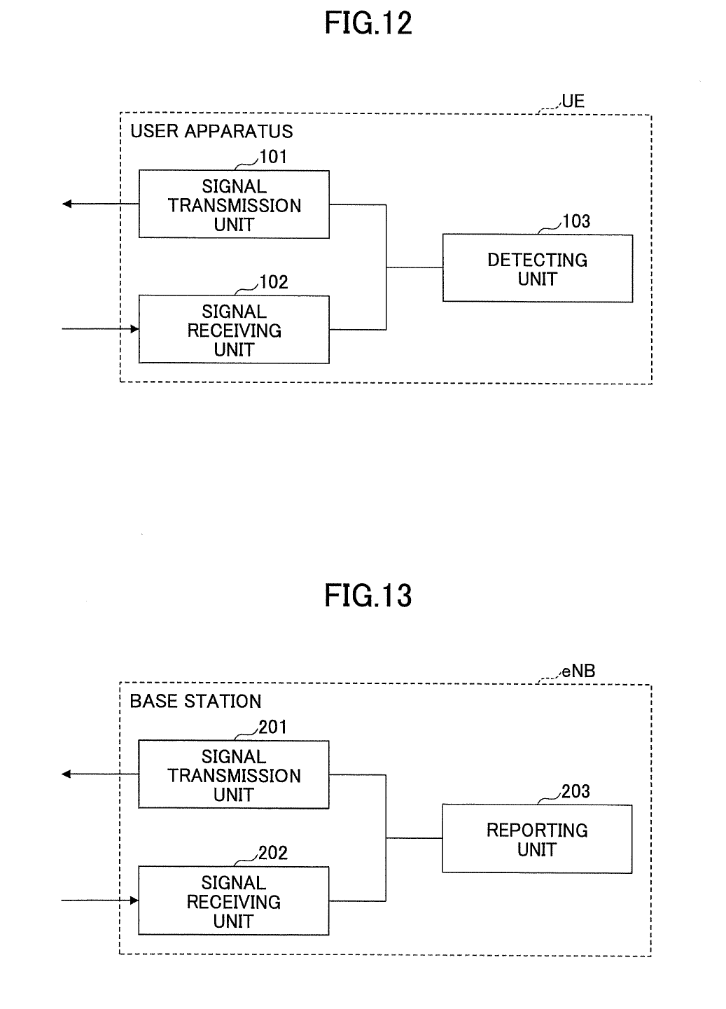

FIG. 13 is a diagram illustrating an example of a functional configuration of a base station according to an embodiment. As illustrated in FIG. 13, the base station eNB includes a signal transmission unit 201, a signal receiving unit 202, and a reporting unit 203. Note that FIG. 13 merely illustrates the functional configuration particularly related to the embodiment of the present invention in the base station eNB, and the base station eNB may also include not-illustrated functions for performing, at the least, operations in compliance with LTE. The functional configuration of the base station eNB illustrated in FIG. 13 is merely an example. Any functional division and any names of the functional components may be applied insofar as the operations according to the present embodiment may be executed.

The signal transmission unit 201 includes a function to generate various types of signals of the physical layer from the signals of a higher layer to be transmitted from the base station eNB and to wirelessly transmit the generated signals. The signal receiving unit 202 includes a function to wirelessly receive various signals from the user apparatus UE and to acquire signals of a higher layer from the received signals of the physical layer.

The reporting unit 203 reports, to the user apparatus UE via the RRC signal, the broadcast information (SIB), and the control signal layer 1 or layer 2, various information (information indicating radio resources allowed only for the user apparatus UE2 having a high priority to transmit an SCI, a predetermined threshold used by the user apparatus UE2 of high priority, a predetermined threshold used by the user apparatus UE1 of low priority, values of “n” and “T”, resource pools for user apparatuses of high priority, etc.) that is used when the user apparatus UE performs a D2D signal transmission process.

### Hardware Configuration

The block diagrams (FIGS. 12 and 13) used in the description of the above embodiment indicate blocks of functional units. These functional blocks (functional components) are implemented by any combination of hardware components or software components. The Components for implementing respective functional blocks are not particularly specified. That is, the functional blocks may be implemented by one physically and/or logically combined device or may be implemented by two or more physically and/or logically separated devices that are directly and/or indirectly connected (e.g., wired and/or wireless connections).

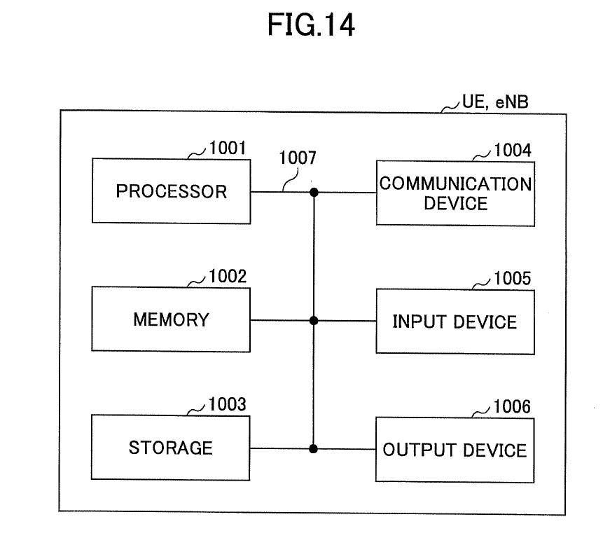

For example, the user apparatus UE and the base station eNB in an embodiment of the present invention may function as a computer that performs processes of a communication method according to the present invention. FIG. 14 is a diagram illustrating an example of a hardware configuration of the user apparatus UE and the base station eNB in an embodiment of the present invention. Each of the base station eNB and the user apparatus UE described above may be physically configured as a computer device including a processor 1001, a memory 1002, a storage 1003, a communication device 1004, an input device 1005, an output device 1006, and a bus 1007.

In the following description, the term “device” may be replaced with a circuit, an apparatus, a unit, or the like. The hardware configuration of the user apparatus UE or the base station eNB may be configured to include one or more of the respective devices illustrated in FIG. 14 or may be configured without including some of the devices.

The functions of the user apparatus UE or the base station eNB are implemented by allowing predetermined software (programs) to be loaded on the hardware such as the processor 1001, the memory 1002, and the like, so as to cause the processor 1001 to perform calculations to control communications by the communication device 1004, and reading and/or writing of data in the storage 1003.

The processor 1001 may, for example, operate an operating system to control the entire computer. The processor 1001 may be configured to include a central processing unit (CPU) having an interface with peripherals, a control device, an operation device, and registers. For example, the signal transmission unit 101, the signal receiving unit 102 and the detecting unit 103 of the user apparatus UE, and the signal transmission unit 201, the signal receiving unit 202 and the reporting unit 203 of the base station eNB may be implemented by the processor 1001.

In addition, the processor 1001 loads programs (program codes), software modules or data from the storage 1003 and/or the communication device 1004 into the memory 1002, and executes various processes according to the loaded programs, software modules or data. The programs are configured to cause a computer to execute at least a part of the operations described in the above embodiment. For example, the signal transmission unit 101, the signal receiving unit 102 and the detecting unit 103 of the user apparatus UE; and the signal transmission unit 201, the signal receiving unit 202 and the reporting unit 203 of the base station eNB may be stored in the memory 1002 and implemented by a control program operated by the processor 1001. Other functional blocks may be implemented in similar manners. The above-described various processes are described as being executed by one processor 1001; however, these processes may be executed simultaneously or sequentially by two or more processors 1001. The processor 1001 may be implemented by one or more chips. Note that the programs may be transmitted from the network via an electric communication line.

The memory 1002 may be a computer-readable recording medium composed of at least one of a ROM (Read Only Memory), an EPROM (Erasable Programmable ROM), an EEPROM (Electrically Erasable Programmable ROM), a RAM (Random Access Memory) and the like. The memory 1002 may be referred to as a register, a cache, a main memory (a main storage device), or the like. The memory 1002 may store executable programs (program codes), software modules, and the like for implementing a communication method according to the embodiment of the present invention.

The storage 1003 is a computer-readable recording medium composed, for example, of at least one of an optical disk such as a CD-ROM (Compact Disk ROM), a hard disk drive, a flexible disk, a magneto-optical disk (e.g., a compact disk, a digital versatile disk, and a Blu-ray [registered trademark] disk), a smart card, a flash memory (e.g., a card, a stick, and a key drive), a floppy [registered trademark] disk, and a magnetic strip. The storage 1003 may be referred to as an auxiliary storage device. The above-described storage medium may be, for example, a database, a server, or another appropriate medium including the memory 1002 and/or the storage 1003.

The communication device 1004 is hardware (a transmitting-receiving device) for performing communications between computers via a wired and/or wireless network. The communication device 1004 may also be referred to as a network device, a network controller, a network card, a communication module, or the like. For example, the signal transmission unit 101 and the signal receiving unit 102 of the user apparatus UE, and the signal transmission unit 201 and the signal receiving unit 202 of the base station eNB may be implemented by the communication device 1004.

The input device 1005 is configured to receive an input from the outside. Examples of the input device include a keyboard, a mouse, a microphone, a switch, a button, and a sensor. The output device 1006 is configured to generate an output to the outside. Examples of the output device include a display, a speaker, and an LED lamp. Note that the input device 1005 and the output device 1006 may be integrated (e.g., a touch panel).

In addition, the respective devices such as the processor 1001 and the memory 1002 may be connected by a bus 1007 for mutually communicating information with one another. The bus 1007 may be composed of a single bus or may be composed of different buses between the devices.

Further, the user apparatus UE or the base station eNB may include hardware such as a microprocessor, a digital signal processor (DSP), an ASIC (Application Specific Integrated Circuit), a PLD (Programmable Logic Device), and an FPGA (Field Programmable Gate Array). Alternatively, a part or all of the functional blocks of the user apparatus UE or the base station eNB may be implemented by these hardware components. For example, the processor 1001 may be implemented with at least one of these hardware components.

### Overview

According to the embodiments disclosed above, a user apparatus in a radio communication system that supports a D2D communication is provided. The user apparatus includes a first transmission unit configured to transmit radio resource allocation information, in a case where a MAC PDU of high priority is transmitted, by using a specific subframe for transmitting radio resource allocation information corresponding to a MAC PDU of high priority, from among radio resources allocated to a D2D control channel; and a second transmission unit configured to transmit the MAC PDU via a D2D data channel in accordance with the transmitted radio resource allocation information. According to the user apparatus UE described above, it is possible to provide a technology to improve the reception rate of high priority data in the D2D communication.

Further, the first transmission unit may transmit the radio resource allocation information including a transmission timing pattern indicating a number of transmission timings enabling MAC PDU transmission that is greater than or equal to a predetermined threshold in a specific radio resource among the radio resources allocated to the D2D communication. This configuration enables transmission of more MAC PDUs in a specific radio resource to improve the reception rate of the MAC PDU of high priority.

In addition, the first transmission unit may transmit the radio resource allocation information including a transmission timing pattern enabling MAC PDU transmission in a specific subframe for transmitting the MAC PDU of high priority, from among radio resources allocated to the D2D data channel. This configuration enables transmission of the MAC PDU of high priority in the specific subframe to further improve the reception rate of high priority data.

Moreover, the second transmission unit may include information indicating that the MAC PDU of high priority is included in a subheader portion and may transmit the MAC PDU via the D2D data channel. This configuration enables the user apparatus UE that has received the MAC PDU to detect that the high priority data is stored in the MAC PDU.

According to the embodiments disclosed above, a user apparatus in a radio communication system that supports a D2D communication is provided. The user apparatus includes a receiving unit configured to receive radio resource allocation information via a D2D control channel and receive a MAC PDU corresponding to the received radio resource allocation information via a D2D data channel; and a transmission unit configured to transmit a MAC PDU for another user apparatus, and to stop transmission of the MAC PDU for the another user apparatus: in a case where the received radio resource allocation information has been received in a specific subframe for transmitting radio resource allocation information corresponding to a MAC PDU of high priority, from among radio resources allocated to the D2D control channel; in a case where the received radio resource allocation information includes information indicating that transmission of the MAC PDU of high priority is scheduled; or in a case where information indicating that the MAC PDU of high priority is included in the subheader of the MAC PDU has been received by the receiving unit.

According to the user apparatus UE described above, it is possible to provide a technology to improve the reception rate of high priority data in the D2D communication.

Further, the transmission unit may stop transmission of the MAC PDU for the another user apparatus in a subframe specified by a transmission timing pattern included in the received radio resource allocation information. This configuration enables the user apparatus UE to transmit the MAC PDU in a sub-frame other than the sub-frame specified by the T-RPT included in the received SCI, such that the user apparatus UE may be able to transmit the MAC PDU for the another user apparatus while receiving the MAC PDU of high priority.

According to the embodiment disclosed above, a communication method to be executed by a user apparatus in a radio communication system that supports a D2D communication is provided. The communication method includes transmitting radio resource allocation information, in a case where a MAC PDU of high priority is transmitted, by using a specific subframe for transmitting radio resource allocation information corresponding to a MAC PDU of high priority, from among radio resources allocated to a D2D control channel; and transmitting the MAC PDU via a D2D data channel in accordance with the transmitted radio resource allocation information. According to the communication method above, it is possible to provide a technology to improve the reception rate of high priority data in the D2D communication.

According to the embodiment disclosed above, a communication method to be executed by a user apparatus in a radio communication system that supports a D2D communication is provided. The communication method includes receiving radio resource allocation information via a D2D control channel and receiving a MAC PDU corresponding to the received radio resource allocation information via a D2D data channel; and transmitting a MAC PDU for another user apparatus, and to stop transmission of the MAC PDU for the another user apparatus: in a case where the received radio resource allocation information has been received in a specific subframe that is used for transmitting radio resource allocation information corresponding to a MAC PDU of high priority, from among radio resources allocated to the D2D control channel; in a case where the received radio resource allocation information includes information indicating that transmission of the MAC PDU of high priority is scheduled; or in a case where information indicating that the MAC PDU of high priority is included in the subheader of the MAC PDU has been received by the receiving unit.

According to the communication method above, it is possible to provide a technology to improve the reception rate of high priority data in the D2D communication.

### Supplementary Description of Embodiment

As described above, the process flows described with reference to FIGS. 7A, 7B, 7C and 7D, FIGS. 8 and 9 may be optionally combined.

The D2D signal, the RRC signal and the control signal may be a D2D message, an RRC message and a control message, respectively.

The embodiment is described by using an example of “a MAC PDU of high priority”; however, the MAC PDU is not limited to the MAC PDU of high priority. The present embodiment may be applied to any MAC PDU insofar as the MAC PDU may be identified from other MAC PDUs.

The PSCCH may be another control channel insofar as the PSCCH is a control channel for transmitting control information (SCI etc.) for use in D2D communications. The PSSCH may be another data channel insofar as the PSSCH is a data channel for transmitting data (MAC PDU, etc.) for use in D2D communications.

The method claims present elements of various steps in a sample order and are not limited to the specific order presented unless explicitly stated in the claims.

As described above, the embodiments of the present invention may be expanded to the LTE, LTE-A, Code Division Multiple Access (CDMA) 2000, UMB (Ultra Mobile Broadband), IEEE 802.11 (Wi-Fi (registered trademark)), IEEE802. 16 (WiMAX (registered trademark)), IEEE 802.20, UWB (Ultra-Wideband), Bluetooth (registered trademark) and/or other suitable systems.

The apparatuses (user apparatus UE/base station eNB) according to the embodiments may include a CPU and a memory, may be realized by having a program executed by the CPU (processor), may be realized by hardware such as hardware circuitry in which the logic described in an embodiment is included, or may be realized by a mixture of a program and hardware.

The embodiments have been described as described above; however, the disclosed invention is not limited to these embodiments, and a person skilled in the art would understand various variations, modifications, replacements, or the like. Specific examples of numerical values have been used for encouraging understanding of the present invention; however, these numerical values are merely examples and, unless otherwise noted, any appropriate values may be used. In the above description, partitioning of items is not essential to the present invention. Provisions described in more than two items may be combined if necessary. Provisions described in one item may be applied to provisions described in another item (as long as they do not conflict). In a functional block diagram, boundaries of functional units or processing units do not necessarily correspond to physical boundaries of parts. Operations of multiple functional units may be physically performed in a single part, or operations of a single functional unit may be physically performed by multiple parts. The order of steps in the above described sequences and flowcharts according to an embodiment may be changed as long as there is no contradiction. For the sake of description convenience, the user apparatus UE and the base station eNB have been described by using functional block diagrams. These apparatuses may be implemented by hardware, by software, or by combination of both. The software which is executed by a processor included in a user apparatus UE according to an embodiment and the software which is executed by a processor included in a base station eNB may be stored in a random access memory (RAM), a flash memory, a read-only memory (ROM), an EPROM, an EEPROM, a register, a hard disk drive (HDD), a removable disk, a CD-ROM, a database, a server, or any other appropriate recording medium.

In the above-described embodiment, the detecting unit 103 and the signal transmission unit 101 are examples of a first transmission unit and a second transmission unit. The detecting unit 103 and the signal receiving unit 102 are examples of a receiving unit. The SC Period for transmitting the “Pre-emption signal” is an example of a specific radio resource among the radio resources allocated to the D2D communication. The SCI is an example of radio resource allocation information. The T-RPT is an example of a transmission timing pattern. The PSCCH is an example of a D2D control channel. The PSSCH is an example of a D2D data channel.

The present application is based on and claims the benefit of priority of Japanese Priority Application No. 2015-159990 filed on Aug. 13, 2015, the entire contents of which are hereby incorporated by reference.

### DESCRIPTION OF REFERENCE SIGNS

UE user apparatus
eNB base station
101 signal transmission unit
102 signal receiving unit
103 detecting unit
201 signal transmission unit
202 signal receiving unit
203 reporting unit
1001 processor
1002 memory
1003 storage
1004 communication device
1005 input device
1006 output device

1. A user apparatus in a radio communication system that supports a Device to Device (D2D) communication, the user apparatus comprising:
a first transmission unit configured to transmit radio resource allocation information, in case of transmitting a Medium Access Control (MAC) Protocol Data Unit (PDU) of high priority, by using a specific subframe that is used for transmitting the radio resource allocation information corresponding to a MAC PDU of high priority from among radio resources allocated to a D2D control channel; and
a second transmission unit configured to transmit the MAC PDU via a D2D data channel in accordance with the transmitted radio resource allocation information.

2. The user apparatus according to claim 1, wherein the first transmission unit transmits the radio resource allocation information including a transmission timing pattern indicating that a number of transmission timings enabled to transmit a MAC PDU is greater than or equal to a predetermined threshold in a specific radio resource among radio resources allocated to the D2D communication.

3. The user apparatus according to claim 1, wherein the first transmission unit transmits the radio resource allocation information including a transmission timing pattern enabling MAC PDU transmission in a specific subframe that is used for transmitting the MAC PDU of high priority from among radio resources allocated to the D2D data channel.

4. The user apparatus according to claim 1, wherein the second transmission unit includes information indicating that the MAC PDU of high priority is included in a subheader portion, and transmits the MAC PDU via the D2D data channel.

5. A user apparatus in a radio communication system that supports a Device to Device (D2D) communication, the user apparatus comprising:
a receiving unit configured to receive radio resource allocation information via a D2D control channel and receive a Medium Access Control (MAC) Protocol Data Unit (PDU) corresponding to the received radio resource allocation information via a D2D data channel; and
a transmission unit configured to transmit a MAC PDU for another user apparatus, and to stop transmission of the MAC PDU for the another user apparatus:
in a case where the received radio resource allocation information has been received in a specific subframe that is used for transmitting the radio resource allocation information corresponding to a MAC PDU of high priority from among radio resources allocated to the D2D control channel;
in a case where the received radio resource allocation information includes information indicating that transmission of the MAC PDU of high priority is scheduled; or
in a case where information indicating that the MAC PDU of high priority is included in a subheader of the MAC PDU that has been received by the receiving unit.

6. The user apparatus according to claim 5, wherein the transmission unit stops transmission of the MAC PDU for the another user apparatus in a subframe specified by a transmission timing pattern included in the received radio resource allocation information.

7. A communication method performed by a user apparatus in a radio communication system that supports Device to Device (D2D) communications, the communication method comprising:
transmitting radio resource allocation information, in case of transmitting a MAC PDU of high priority, by using a specific subframe that is used for transmitting radio resource allocation information corresponding to a Medium Access Control (MAC) Protocol Data Unit (PDU) of high priority from among radio resources allocated to a D2D control channel; and
transmitting the MAC PDU via a D2D data channel in accordance with the transmitted radio resource allocation information.

8. A communication method performed by a user apparatus in a radio communication system that supports Device to Device (D2D) communications, the communication method comprising:
receiving a radio resource allocation information via a D2D control channel and receiving a Medium Access Control (MAC) Protocol Data Unit (PDU) corresponding to the received radio resource allocation information via a D2D data channel; and
transmitting a MAC PDU for another user apparatus, and to stop transmission of the MAC PDU for the another user apparatus:
in a case where the received radio resource allocation information has been received in a specific subframe that is used for transmitting the radio resource allocation information corresponding to a MAC PDU of high priority from among radio resources allocated to the D2D control channel;
in a case where the received radio resource allocation information includes information indicating that transmission of the MAC PDU of high priority is scheduled; or
in a case where information indicating that the MAC PDU of high priority is included in a subheader of the MAC PDU that has been received by the receiving unit.

9. The user apparatus according to claim 2, wherein the first transmission unit transmits the radio resource allocation information including the transmission timing pattern enabling MAC PDU transmission in a specific subframe that is used for transmitting the MAC PDU of high priority, from among radio resources allocated to the D2D data channel.

10. The user apparatus according to claim 2, wherein the second transmission unit includes information indicating that the MAC PDU of high priority is included in a subheader portion, and transmits the MAC PDU via the D2D data channel.

11. The user apparatus according to claim 3, wherein the second transmission unit includes information indicating that the MAC PDU of high priority is included in a subheader portion, and transmits the MAC PDU via the D2D data channel.
